(19) United States
(12) Patent Application Publication
(10) Pub. No.: US 2026/0021494 A1
(43) Pub. Date: Jan. 22, 2026

(54) ROTATIONAL LOCKING SYSTEM FOR ATTACHING A ROTOR

(71) Applicant: FIBERLITE CENTRIFUGE LLC, Santa Clara, CA (US)

(72) Inventor: Sina PIRAMOON, Santa Clara, CA (US)

(21) Appl. No.: 18/996,046

(22) PCT Filed: Jul. 18, 2023
(86) PCT No.: PCT/US2023/028070

§ 371 Date: Jan. 17, 2025

Related U.S. Application Data
(60) Provisional application No. 63/390,428, filed on Jul. 19, 2022.

(51) Int. Cl. B04B 9/08

(52) U.S. Cl. CPC B04B 9/08; B04B 2009/085

(57) ABSTRACT

A drive head (20) of a centrifuge drive for detachably connecting a rotor to the centrifuge. The drive head includes a drive head hub (58) including a plurality of recesses (62) formed in an outer sidewall, a locking shoe (66) movably retained within each of the plurality of recesses to define a hinge joint and pivotable about a hinge axis in a radially inward direction and a radially outward direction, and a resilient element for biasing each locking shoe in the radially inward direction. Each locking shoe is configured to exert a radially outwardly directed force (A2) on an interior sidewall of the hub (22) of the centrifuge rotor to prevent axial movement of the centrifuge rotor along the rotational axis of the centrifuge drive and rotational movement of the centrifuge rotor relative to the drive head, with the radially outwardly directed force increasing with a rising rotational speed of the drive head.

### TECHNICAL FIELD

This invention relates generally to centrifuges and, more particularly, to a drive head locking system of a centrifuge drive for detachably connecting a rotor to the centrifuge.

### BACKGROUND

Laboratory centrifuges generally include a rotor removably coupled to a drive for rotating the rotor at a particular speed required for the centrifuging of samples stored in the rotor. While centrifuge rotors may vary significantly in construction and in size, common rotor structures are a fixed-angle rotor and a swinging-bucket rotor (also referred to as a swing-out rotor). The fixed-angle rotor, for example, includes a solid rotor body with a plurality of receiving chambers, or rotor wells, distributed radially within the rotor body and arranged symmetrically about an axis of rotation of the rotor. Samples in sample containers of appropriate size are placed in the plurality of rotor wells, allowing a plurality of samples to be subjected to centrifugation when the rotor is rotated by the centrifuge drive.

To cause the rotor to rotate at a particular speed, the rotor is removably attached to a drive shaft, or spindle, of the centrifuge that is driven by a motor. In this regard, the centrifuge spindle typically includes a locking system configured to be received by the rotor for both securing the rotor to the centrifuge drive and transmitting torque between the drive and the rotor for rotation of the rotor at a particular speed. One type of conventional locking system is one that is operated by centrifugal force. That is, with increasing rotational speed of the rotor, the coupling force exerted by the coupling device on the rotor increases. However, these conventional types of locking systems often require the use of tools to initially couple and to decouple the rotor and the centrifuge drive. Other conventional locking system designs include an integrated actuator or push button operable to initially couple and to decouple the rotor and the centrifuge drive, for example. To this end, the use of tools or other mechanisms to mechanically couple the rotor to the centrifuge drive is a result of the limited performance capabilities of centrifugally operated locking systems, being limited by their ability to accommodate torque and the associated axial forces caused by centrifugal forces during rotation of the centrifuge rotor by the centrifuge drive, particularly at high rotational speeds.

Therefore, a need exists to provide a centrifuge which ensures reliable locking against both rotational forces and axial lifting forces acting against the centrifuge rotor during a range of rotational speeds, but particularly at high rotational speeds, with the locking force increasing with the rising rotational speed of the centrifuge rotor. Furthermore, the rotor should be able to be mountable to and dismountable from the centrifuge drive in a very short period of time and without the use of tools, pushbuttons, or other mechanical actuators, for example.

### SUMMARY

The present invention overcomes the foregoing and other shortcomings and drawbacks of centrifuge drive head locking systems for detachably connecting a rotor to the centrifuge drive. While the present invention will be discussed in connection with certain embodiments, it will be understood that the present invention is not limited to the specific embodiments described herein.

According to one embodiment of the invention, a drive head for a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The hub of the centrifuge rotor includes at least one torque slot formed therein. The drive head includes a drive head hub having a spindle socket configured to receive a spindle of the centrifuge drive and a central bore configured to receive a fastener therethrough to couple the drive head to the spindle. The drive head hub includes a boss that projects upwardly from a top surface of the drive head hub, the boss including at least one drive pin configured to engage the at least one torque slot formed in the hub of the centrifuge rotor to transfer rotational movement of the centrifuge drive to the centrifuge rotor, a plurality of recesses formed in an outer sidewall of the drive head hub and spaced circumferentially about the drive head hub, and a locking shoe movably retained within each of the plurality of recesses to define a hinge joint and a hinge axis and pivotable about the hinge axis in a radially inward direction and a radially outward direction relative to the rotational axis of the centrifuge drive. A resilient element is located between each locking shoe and the drive head hub for biasing each locking shoe in the radially inward direction relative to the rotational axis of the centrifuge drive. To this end, each locking shoe is configured to exert a radially outwardly directed force on an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

According to one aspect of the present invention, the drive head includes a retaining plate attached to a base of the drive head hub. The retaining plate includes a central bore configured to receive a distal end of the spindle therethrough. According to another aspect, the at least one drive pin of the drive head includes a first, second, and third drive pin spaced apart circumferentially about the central bore of the drive head hub.

According to another aspect of the present invention, each locking shoe includes a curved outer surface in transverse cross-section that matches a curvature of the interior sidewall of the hub of the centrifuge rotor. According to another aspect, each locking shoe includes a chamfered surface that extends between the curved outer surface and a top surface of each locking shoe. According to yet another aspect, each locking shoe is pivotable between (1) a retracted position where each locking shoe is received within a corresponding one of the plurality of recesses in a radially inward direction relative to the rotational axis of the centrifuge drive to define a first outer diameter of the drive head hub and (2) an extended position where each locking shoe projects a distance from the corresponding one of the plurality of recesses in a radially outward direction relative to the rotational axis of the centrifuge drive to define a second outer diameter of the drive head hub that is greater than the first outer diameter.

According to one aspect of the present invention, the plurality of recesses are spaced equidistantly apart about a circumference of the drive head hub to provide self-centering of the drive head within the hub of the centrifuge rotor by each locking shoe. According to another aspect, the hinge axis is in parallel with the rotational axis of the centrifuge drive.

According to an aspect of the present invention, each locking shoe includes a hinge member configured to be movable within a socket portion of each of the plurality of recesses and a bore formed in the retaining plate to define the hinge joint. According to another aspect, a first end of the hinge member includes a peg having a bushing configured to facilitate pivotal movement between the locking shoe and the drive head hub and a second end of the hinge member includes a peg having a bushing configured to facilitate pivotal movement between the locking shoe and the retaining plate.

According to yet another aspect, the locking shoe includes a first radially extending sidewall portion and a second radially extending sidewall portion. The first radially extending sidewall portion is configured to abut a first radially extending surface of the drive head hub when the locking shoe is in the extended position and the second radially extending sidewall portion is configured to abut a second radially extending surface of the drive head hub when the locking shoe is in the retracted position.

According to one aspect, the resilient element extends between a blind bore formed in the first radially extending surface of the drive head hub and a blind bore formed in the first radially extending sidewall portion of the locking shoe.

According to another aspect of the invention, a centrifuge is provided with the drive head and includes a centrifuge rotor having a hub configured to receive the drive head therein. The hub includes at least one torque slot formed therein that is configured to receive the at least one drive pin of the drive head hub for transferring rotational movement of the centrifuge drive to the centrifuge rotor. According to yet another aspect, each torque slot is an arc-shaped blind bore. According to one aspect, the at least one torque slot includes four torque slots spaced apart circumferentially about a central bore formed in the hub. According to another aspect, a first drive pin of the drive head hub is configured to engage a sidewall of a first torque slot to prevent rotation of the drive head relative to the centrifuge rotor during acceleration of the centrifuge rotor by the centrifuge drive. According to yet another aspect, a second drive pin of the drive head hub is configured to engage a sidewall of a second torque slot to prevent rotation of the drive head relative to the centrifuge rotor during deceleration of the centrifuge rotor by the centrifuge drive.

According to another embodiment of the present invention, a drive head for a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The hub of the centrifuge rotor includes at least one drive pin for transferring rotational movement of the centrifuge drive to the centrifuge rotor. The drive head includes a drive head hub with a spindle socket configured to receive a spindle of the centrifuge drive and a central bore configured to receive a fastener therethrough to couple the drive head to the spindle. The drive head hub includes a plurality of recesses formed in an outer sidewall of the drive head hub and spaced circumferentially about the drive head hub, a locking shoe movably retained within each of the plurality of recesses to define a hinge joint and a hinge axis and pivotable about the hinge axis in a radially inward direction and a radially outward direction relative to the rotational axis of the centrifuge drive, and a resilient element located between each locking shoe and the drive head hub for pivotally biasing each locking shoe in the radially inward direction relative to the rotational axis of the centrifuge drive. To this end, each locking shoe is configured to exert a radially outwardly directed force on an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

According to one aspect of the invention, the drive head includes a crown attached to a top of the drive head hub. The crown includes a central bore configured to receive the fastener therethrough and a plurality of torque slots formed in a top surface of the crown that are configured to receive the at least one drive pin of the hub of the centrifuge rotor therein to transfer rotational movement of the centrifuge drive to the centrifuge rotor. The drive head also includes a retaining plate attached to a base of the drive head hub. The retaining plate includes a central bore configured to receive a distal end of the spindle therethrough.

According to another aspect, each locking shoe includes a curved outer surface in transverse cross-section that matches a curvature of the interior sidewall of the hub of the centrifuge rotor. According to one aspect, each locking shoe includes a chamfered surface that extends between the curved outer surface and a top surface of each locking shoe. According to another aspect, each locking shoe is pivotable between (1) a retracted position where each locking shoe is received within a corresponding one of the plurality of recesses in a radially inward direction relative to the rotational axis of the centrifuge drive to define a first outer diameter of the drive head hub and (2) an extended position where each locking shoe projects a distance from the corresponding one of the plurality of recesses in a radially outward direction relative to the rotational axis of the centrifuge drive to define a second outer diameter of the drive head hub that is greater than the first outer diameter.

According to an aspect of the invention, the plurality of recesses are spaced equidistantly apart about a circumference of the drive head hub to provide self-centering of the drive head within the hub of the centrifuge rotor by each locking shoe. According to another aspect, the hinge axis is in parallel with the rotational axis of the centrifuge drive.

According to yet another aspect, each locking shoe includes a hinge member configured to be movable within a socket portion of each of the plurality of recesses, a blind bore formed in the crown, and a bore formed in the retaining plate to define the hinge joint. According to one aspect, a first end of the hinge member includes a peg having a bushing configured to facilitate pivotal movement between the locking shoe and the crown and a second end of the hinge member includes a peg having a bushing configured to facilitate pivotal movement between the locking shoe and the retaining plate.

According to one aspect of the present invention, the locking shoe includes a first radially extending sidewall portion and a second radially extending sidewall portion. The first radially extending sidewall portion is configured to abut a first radially extending surface of the drive head hub when the locking shoe is in the extended position and the second radially extending sidewall portion is configured to abut a second radially extending surface of the drive head hub when the locking shoe is in the retracted position. According to another aspect, the resilient element extends between a blind bore formed in the first radially extending surface of the drive head hub and a blind bore formed in the first radially extending sidewall portion of the locking shoe.

According to another aspect of the invention, a centrifuge is provided with the drive head and includes a centrifuge rotor having a hub configured to receive the drive head therein. The hub includes at least one drive pin that projects from an interior surface of the hub in an axially downward direction relative to the rotational axis of the centrifuge drive. To this end, the at least one drive pin configured to transfer rotational movement of the centrifuge drive to the centrifuge rotor. According to another aspect, each torque slot is an arc-shaped blind bore. According to one aspect, the at least one torque slot comprises four torque slots spaced apart circumferentially about a central bore formed in the hub. According to another aspect, a first drive pin of the crown is configured to engage a sidewall of a first torque slot to prevent rotation of the drive head relative to the centrifuge rotor during acceleration of the centrifuge rotor by the centrifuge drive. According to yet another aspect, a second drive pin of the crown of the centrifuge rotor is configured to engage a sidewall of a second torque slot to prevent rotation of the drive head relative to the centrifuge rotor during deceleration of the centrifuge rotor by the centrifuge drive.

According to another embodiment of the invention, an adapter for mounting a drive head to a spindle of a centrifuge drive is provided. The drive head is configured to be received within a hub of a centrifuge rotor for coupling the centrifuge rotor to the centrifuge drive for rotation of the centrifuge rotor by the centrifuge drive about a rotational axis of the centrifuge drive. The drive head includes a central bore configured to receive a fastener therethrough to couple the drive head to a distal end of the spindle of the centrifuge drive. The adapter includes a first projection configured to be received within a pocket formed in the drive head, a second projection that projects in an axially opposite direction from the first projection, and a mounting bore that extends axially through the adapter and between a first opening to the mounting bore formed in the first projection of the adapter and a second opening to the mounting formed in the second projection of the adapter. The mounting bore is configured to receive the distal end of the spindle through the second opening such that the central bore of the drive head, the mounting bore, and a threaded bore in the distal end of the spindle are coaxially arranged to receive the fastener therethrough to couple the drive head and the adapter to the distal end of the spindle of the centrifuge drive.

According to one aspect of the present invention, the adapter includes a cupped flange located axially between the first projection and the second projection. According to another aspect, the first projection is frustoconical in shape. According to yet another aspect, the mounting bore is frustoconical in shape.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a cross-sectional view of a centrifuge, illustrating a centrifuge rotor coupled to a drive head of a centrifuge drive in accordance with a first embodiment of the invention.

FIG. 2 is an enlarged cross-sectional view of the centrifuge of FIG. 1, illustrating a locking shoe of the drive head exerting a radially outwardly directed force on an interior sidewall of a hub of the centrifuge rotor when the drive head is rotating the centrifuge rotor at a particular speed.

FIG. 3 is a sectional view taken along line 3-3 in FIG. 2, illustrating a position of the locking shoes of the drive head when the drive head is stationary.

FIG. 4 is a view similar to FIG. 3, illustrating forces acting on locking shoes of the drive head when the drive head is rotating the centrifuge rotor at a particular speed.

FIG. 5 is a cross-sectional view taken along line 5-5 in FIG. 4, illustrating details of the drive head and a locking shoe.

FIG. 6 is a cross-sectional view taken along line 6-6 in FIG. 2, illustrating a position of drive pins relative to corresponding torque slots in the drive head when the drive head is rotating the centrifuge rotor at a particular speed in a counterclockwise direction.

FIG. 7 is a view similar to FIG. 6, illustrating a position of drive pins relative to corresponding torque slots in the drive head when the drive head is decelerating to a stop.

FIG. 8 is an exploded disassembled view of the drive head of FIGS. 1-7.

FIG. 9 is an enlarged cross-sectional view of a centrifuge, illustrating a centrifuge rotor coupled to a drive head of a centrifuge drive in accordance with a second embodiment of the invention.

FIG. 10 is a view similar to FIG. 9, illustrating additional details of the drive head and the locking shoe.

FIG. 11 is a sectional view taken along line 11-11 in FIG. 9, illustrating a position of drive pins relative to corresponding torque slots in a hub of the centrifuge rotor when the drive head is rotating the centrifuge rotor at a particular speed in a counter clockwise direction.

FIG. 12 is a view similar to FIG. 11, illustrating a position of drive pins relative to corresponding torque slots in the hub of the centrifuge rotor when the drive head is decelerating to a stop.

FIG. 13 is a cross-sectional view of a drive head attached to a spindle of a centrifuge with an adapter in accordance with an embodiment of the invention.

FIG. 14 is a diagrammatic view showing a centrifuge rotor installed in an exemplary centrifuge.

### DETAILED DESCRIPTION

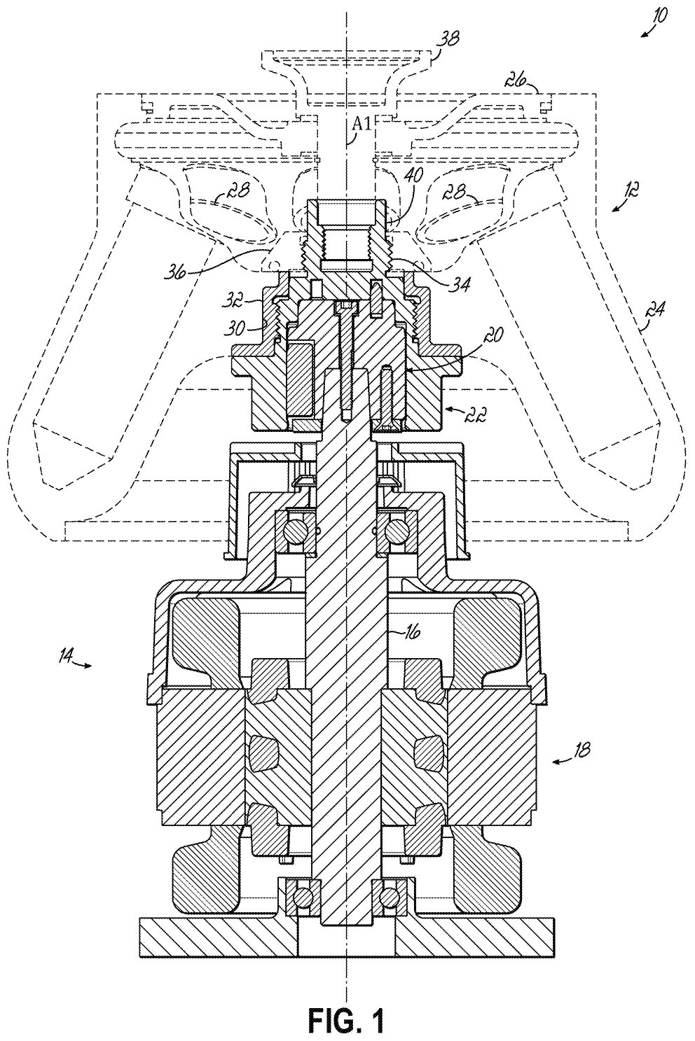

Referring now to the figures, and in particular to FIG. 1, an exemplary centrifuge 10 in accordance with a first embodiment of the present invention is shown without any substructure of the centrifuge 10. As shown in FIG. 1, the centrifuge 10 includes a centrifuge rotor 12 operatively coupled to a centrifuge drive 14 having a drive shaft, or spindle 16, driven by a motor 18 for rotating the rotor 12 about a rotational axis A1 to achieve high-speed, centrifugal rotation of the rotor 12. As shown, the centrifuge drive 14 includes a drive head 20 positioned at one end of the spindle 16 that is configured to be received within a hub 22 of the rotor 12 for detachably connecting the rotor 12 to the centrifuge drive 14 in a tool-less manner, as will be described in further detail below. The connection between the drive head 20 and the rotor 12 both axially secures the rotor 12 to the centrifuge drive 14 as well as facilitates the transfer of torque between the centrifuge drive 14 and the rotor 12 to cause the rotor 12 to rotate with a rotation required for centrifugation of samples contained therein. The connection also provides for self-centering of the drive head 20 within the hub 22 of the rotor 12, as will be described in further detail below.

With continued reference to FIG. 1, the exemplary centrifuge rotor 12 includes a rotor body 24 and a rotor lid 26 configured to be coupled to an open end of the rotor body 24, particularly during centrifugation of a sample, for example. In that regard, the rotor body 24 is symmetrical about the axis of rotation A1 shared with the centrifuge drive 14. The rotor 12 includes a plurality of rotor wells 28 (otherwise referred to as receiving chambers or cell hole cavities) formed in the rotor body 24 and distributed radially, in a symmetrical arrangement, about a vertical bore 30 formed through the axial center of the rotor 12. Each rotor well 28 formed in the rotor body 24 is generally cylindrical in shape and is configured to receive a sample container (not shown) therein for centrifugation of a sample held in the sample container. Each rotor well 28 may be formed in the rotor body 24 so as to have a fixed angular relationship relative to the rotational axis A1 of the rotor 12. To this end, the rotor 12 may be considered a high-speed fixed-angle rotor 12, for example, which is designed to rotate at rotational speeds in the range of about 8,000 rpm to about 30,000 rpm.

While the rotor 12 is shown and described in the context of a fixed-angle rotor having certain characteristics, it will be understood that the same inventive concepts related to embodiments of the present invention may be implemented with different types of centrifuge rotors such as swinging-bucket rotors and vertical rotors, for example, without departing from the scope of the invention. For example, the inventive concepts related to embodiments of the present invention may be implemented with the following rotors (listed by model number) commercially available from the Assignee of the present disclosure: Fiberlite™ F10-6×250 LEX, Fiberlite™MF10-6×100 LEX, Fiberlite™F15-6×100y, Fiberlite™F15-8×50cy, Fiberlite™ F15-48×1.5/2.0, Fiberlite™F10-14×50cy, H3-LV, Fiberlite™F15-24×1.5/2.0, BIOShield™-720, TX-100, TX-150, TX-200, TX-400, TX-750, HIGHPlate™-6000. To this end, the drawings are not intended to be limiting.

With continued reference to FIG. 1, the rotor 12 includes a rotor insert 32 provided within a central interior region of the rotor body 24 that is configured to threadably engage the rotor hub 22. As shown, the rotor insert 32 is located about the rotational axis A1 and is configured to receive and threadedly engage the rotor hub 22 to hold the rotor hub 22 in place within the vertical bore 30 of the rotor 12. The engagement between the rotor insert 32 and the rotor hub 22 results in an externally threaded top portion 34 of the hub 22 being exposed from the vertical bore 30 to which a hub retainer 36 is threadably fastened to hold the hub 22 in place relative to the rotor body 24.

The rotor 12 further includes a lid screw 38 for securing the rotor lid 26 to the rotor body 24. The lid screw 38 is configured to thread into an internally threaded top portion 40 of the rotor hub 22 such that turning of the lid screw 38 to engage the hub 22 causes the lid screw 38 to press down on the lid 26, securing the lid 26 to the rotor 12. As shown, the lid screw 38, hub 22, and rotor insert 32 are coaxially arranged with the vertical bore 30 formed in the rotor body 24. The lid 26 seals closed the open end of the rotor body 24 to block access to one or more sample containers held in the rotor wells 28 during high speed rotation of the rotor 12.

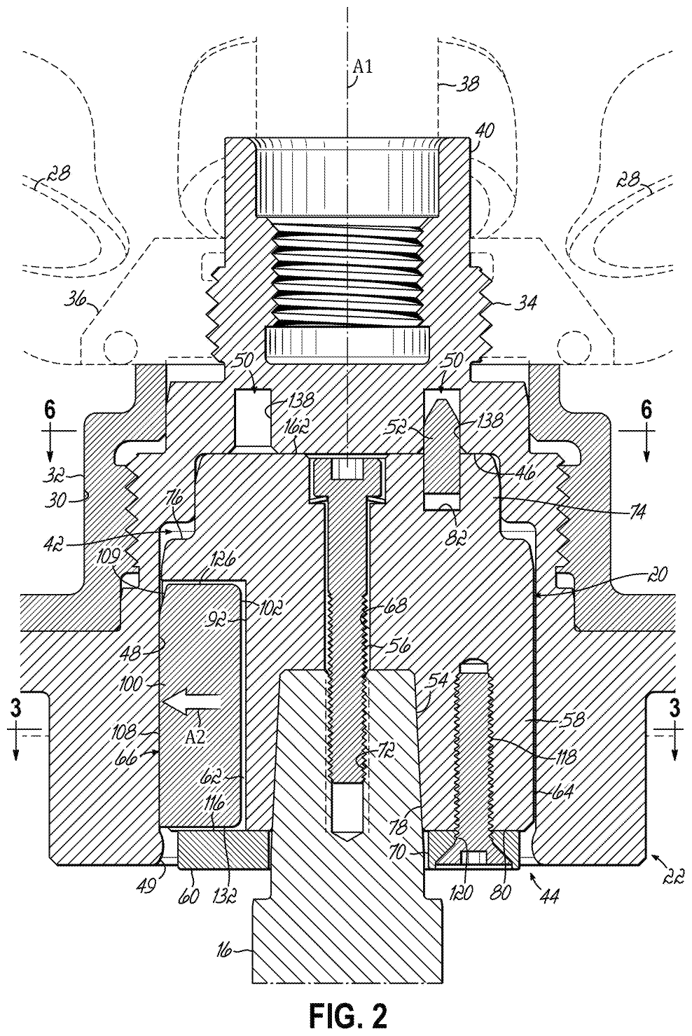

Referring now to FIGS. 1-2, the hub 22 of the rotor 12 includes an internal cavity 42 configured to receive the drive head 20 of the centrifuge drive 14 therein for coupling the rotor 12 to the centrifuge drive 14. In that regard, a shape of the cavity 42 generally corresponds to a profile of the drive head 20. More particularly, the internal cavity 42 extends from an open end 44 of the hub 22 to a radially extending base surface 46 of the hub 22 to define an interior sidewall 48 of the hub 22. The interior sidewall 48 of the hub 22 includes an annular lip 49 adjacent the open end 44 and the base surface 46 of the hub 22 includes a plurality of torque slots 50 formed therein with each torque slot 50 being configured to receive a corresponding drive pin 52 of the drive head 20 therein to transfer rotational movement of the centrifuge drive 14 to the centrifuge rotor 12, as described in further detail below.

With reference to FIGS. 1-2, 5 and 8, details of the drive head 20 will now be described. As shown, the drive head 20 is permanently mounted to a distal end 54 of the spindle 16 with a fastener 56 and includes a drive head hub 58 and a retaining plate 60 coupled together in a coaxial arrangement. The drive head hub 58 further includes a plurality of recesses 62 formed in an outer sidewall 64 of the drive head hub 58 with each recess 62 being configured to movably retain a respective locking shoe 66 therein. The plurality of radially movable locking shoes 66 are configured to exert a radially outwardly directed force on the hub 22 of the rotor 12, as indicated by directional arrow A2 in FIG. 2, for example. The radially outwardly directed force A2 exerted on the hub 22 of the rotor 12 by each locking shoe 66 increases with a rising rotational speed of the drive head 20. In that regard, the locking shoes 66 serve to prevent axial movement of the centrifuge rotor 12 along the rotational axis A1 of the centrifuge drive 14 as well as rotational movement of the centrifuge rotor 12 relative to the drive head 20, and further provide for self-centering of the drive head 20 within the hub 22 of the rotor 12, as described in further detail below. As best shown in FIG. 2, the drive head hub 58 includes a central bore 68 configured to receive the fastener 56 therethrough for attaching the drive head 20 to the distal end 54 of the spindle 16. The retaining plate 60 includes a central bore 70 configured to receive the distal end 54 of the spindle 16 therethrough. To this end, the fastener 56, which may be a bolt or screw, for example, is received through the bore 68 formed in the drive head hub 58 and threaded into a threaded bore 72 in the distal end 54 of the spindle 16.

With continued reference to FIGS. 1-2, 5 and 8, the drive head hub 58 includes a generally cylindrical boss 74 that projects upwardly from a top surface 76 of the drive head hub 58 and a pocket 78, otherwise referred to as a spindle socket, formed in a base 80 of the drive head hub 58. The pocket 78 extends a distance into the drive head hub 58 in an axial direction from the base 80 and is configured to receive a portion of the distal end 54 of the spindle 16 therein, as shown. The profile of the pocket 78 achieves the same effect as a locking cone or morse taper, resulting in a self-holding frictional engagement between surfaces of the pocket 78 and surfaces of the spindle 16. The central bore 68 formed in the drive head hub 58 extends in an axial direction between the boss 74 and the pocket 78 and is configured to receive the fastener 56 therethrough, as described above.

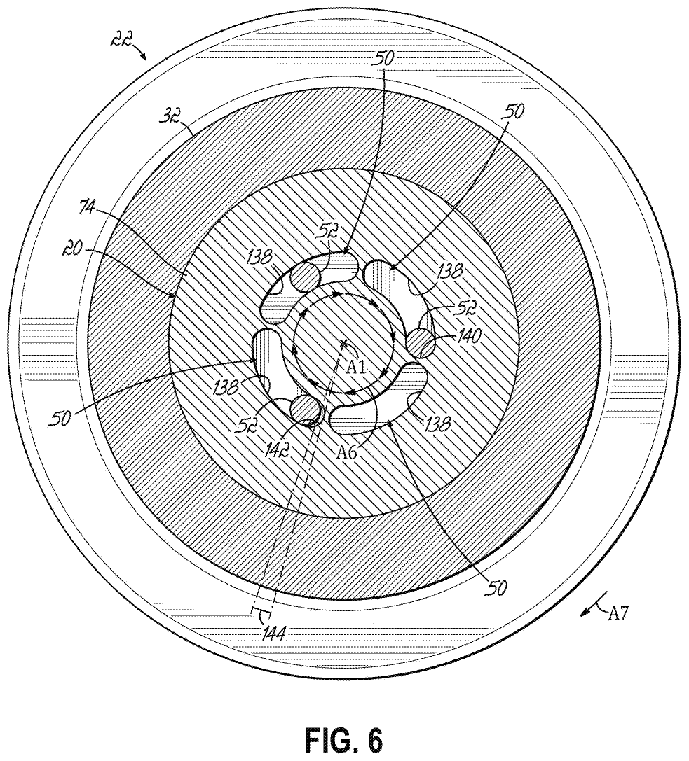

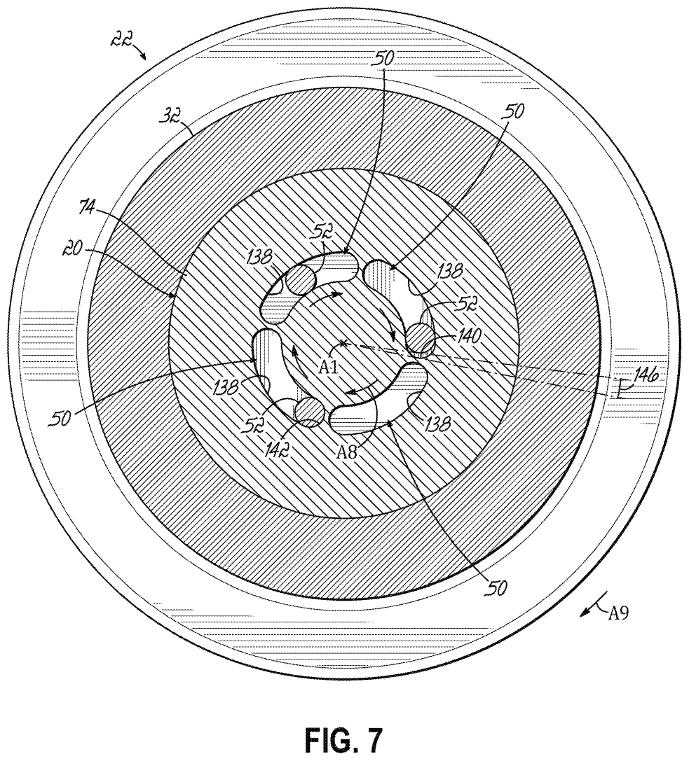

With continued reference to FIGS. 1-2, 5 and 8, the drive head hub 58, and more particularly the boss 74, includes a plurality of blind bores 82 formed therein with each blind bore 82 being configured to receive a respective drive pin 52 therein. As briefly described above, the drive pins 52 are configured to engage the rotor hub 22 to transfer rotational movement of the centrifuge drive 14 to the rotor 12. With brief reference to FIGS. 6-7, the drive head hub 22 includes three drive pins 52 (i.e., a first, second, and third drive pin 52) spaced apart circumferentially about the central bore 68 of the drive head hub 58. In that regard, the blind bore 82 and drive pin 52 combinations are spaced 120° apart from each other about the axial center of the hub 22 which is coaxial with the rotational axis A1. However, the drive head hub 58 may include fewer or more blind bore 82 and drive pin 52 combinations spaced apart in different configurations about the axial center of the drive head hub 58. For example, the drive head hub 58 may include two drive pin 52 and blind bore 82 combinations spaced 180° apart from each other about the axial center of the drive head hub 58. In any event, the engagement between each drive pin 52 and blind bore 82 is an interference fit, otherwise referred to as a press-fit. As a result, there may be a void between a base of each blind bore 82 and the drive pin 52, as shown in FIG. 2. However, it is understood that the drive pins 52 may be attached to the drive head hub 58 in other ways, such as by welding or by threaded engagement, for example. In one embodiment, the drive head hub 58 and the drive pins 52 may be integrally formed as a unitary piece.

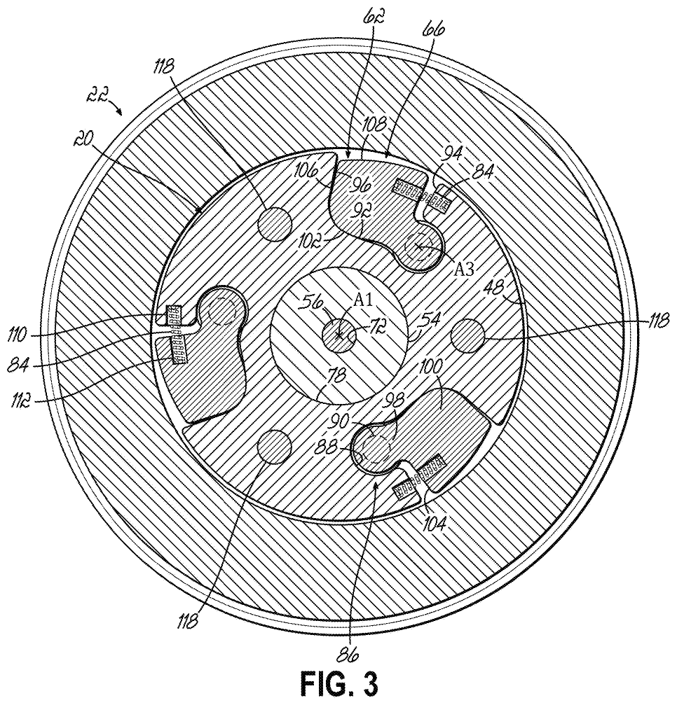

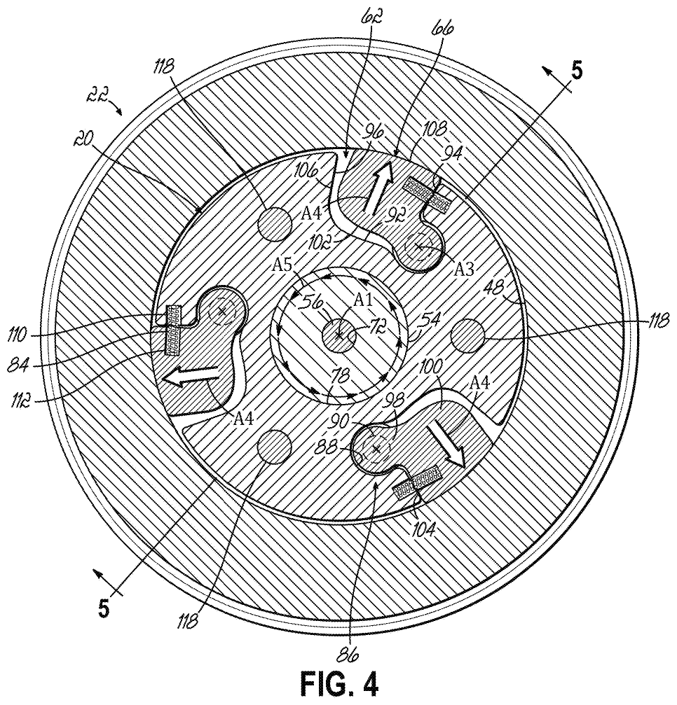

With reference to FIGS. 3 and 4, the plurality of recesses 62 are spaced equidistantly apart and circumferentially about the drive head hub 58 so as to be in a symmetrical arrangement. In that regard, the three locking shoes 66 are spaced 120° apart from each other about the axial center of the drive head hub 58 so as to be positioned at 0°, 120°, and 240° thereabout. The symmetrical arrangement of the plurality of recesses 62 and locking shoes 66 about the drive head hub 58 provides for self-centering of the drive head 20 within the hub 22 of the rotor 12, as will be described in further detail below. While the drive head hub 58 includes three locking shoes 66, it is possible to provide fewer or more locking shoes 66. For example, the drive head hub 58 may include four locking shoes 66 spaced 90° apart from each other about the axial center of the drive head hub 58 so as to be positioned at 0°, 90°, 180°, and 270° thereabout.

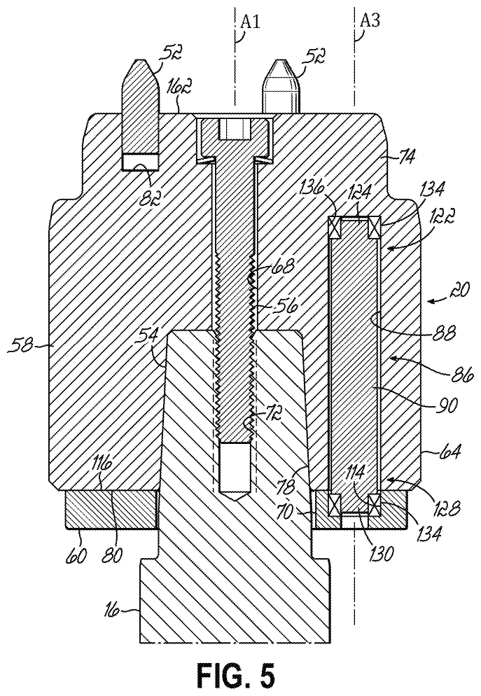

Referring now to FIGS. 3-5, each locking shoe 66 is received within a corresponding recess 62 so as to be movable in a radially inward direction and a radially outward direction relative to the rotational axis A1 of the centrifuge drive 14. A resilient element 84 is located between each locking shoe 66 and the drive head hub 58 to bias each locking shoe 66 in a radially inward direction relative to the rotational axis A1 of the centrifuge drive 14, as will be described in further detail below. Each locking shoe 66 is movably retained within a corresponding recess 62 to define a hinge joint 86 and a hinge axis A3 about which the locking shoe 66 may be pivoted. In that regard, each recess 62 includes a socket portion 88 configured to receive a hinge member 90 of a corresponding locking shoe 66 therein. The engagement between the socket portion 88 and the hinge member 90 defines the hinge joint 86 for each locking shoe 66. As shown in FIG. 5, the hinge axis A3 is in parallel with the rotational axis A1 of the centrifuge drive 14.

As shown, the socket portion 88 of each recess 62 defines a cylindrically shaped socket sized to movably receive the hinge member 90 of the locking shoe 66 therein and prevent the locking shoe 66 from being pulled out or removed from the recess 62. Specifically, the socket portion 88 of each recess 62 is defined by a curved surface that extends from a base surface 92 of the recess 62 to a first radially extending abutment surface 94 of the recess 62. Opposite the first radially extending abutment surface 94 of the recess 62 is a second radially extending abutment surface 96 of the recess 62. As shown in FIG. 3, for example, the curved surface that defines the socket portion 88 curves slightly inwardly on itself just before the first radially extending abutment surface 94 and in a direction toward a neck 98 of the locking shoe 66 to thereby retain the hinge member 90 of the locking shoe 66 within the socket defined by the socket portion 90 of the recess 62. That way, the locking shoe 66 is movably retained within the recess 62. To this end, the curved surface that defines the socket portion 90 may extend about a majority of the hinge member 90.

With reference to FIGS. 3-5 and 8, each locking shoe 66 is generally “L” shaped in transverse cross-section and includes the hinge member 90 and a boss 100. The transition region between the hinge member 90 and the boss 100 defines the neck 98, which is region of the locking shoe 66 where the thickness (i.e., a width of the material measured between a radially outwardly facing surface of the locking shoe 66 and a radially inwardly facing surface) is the smallest. In any event, the boss 100 defines an inner sidewall 102, a first radially extending sidewall 104, a second radially extending sidewall 106, and a curved outer surface 108 of the locking shoe 66. The curved outer surface 108 of each locking shoe 66 generally matches a curvature of the interior sidewall 48 of the hub 22 of the rotor 12, as shown in FIGS. 3 and 4, for example. To this end, each locking shoe 66 may include a curved or chamfered surface 109 that extends between the curved outer surface 108 and a top surface 126 of each locking shoe 66.

As shown in FIGS. 3 and 4, each locking shoe 66 is movable between at least a first, retracted position (FIG. 3) where each locking shoe 66 is received within a corresponding one of the plurality of recesses 62 in a radially inward direction relative to the rotational axis A1 of the centrifuge drive 14 to define a first outer diameter of the drive head hub 58, and a second, extended position (FIG. 4) where each locking shoe 66, and in particular the boss 100 of each locking shoe 66, extends a distance from the corresponding one of the plurality of recesses 62 in a radially outward direction relative to the rotational axis A1 of the centrifuge drive 14 such that the locking shoes 66 define a second outer diameter of the drive head hub 58 that is greater than the first outer diameter. Each locking shoe 66 is in the first, retracted position when the rotor 12 is stationary, for example, as shown in FIG. 3. When so positioned, a portion of the second radially extending sidewall 106 of each locking shoe 66 is in contact with a portion of the second radially extending abutment surface 96 of the drive head hub 22. To this end, when each locking shoe 66 is in the second, extended position, such as when the rotor 12 is rotating at a particular speed as shown in FIG. 4, for example, a portion of the first radially extending sidewall 104 is in contact with a portion of the first radially extending abutment surface 94 of the drive head hub 22. The curved outer surface 108 of each locking shoe 66 is also in contact with the interior sidewall 48 of the hub 22 of the rotor 12 when the locking shoe 66 is in the extended position, as shown in FIG. 4.

With continued reference to FIGS. 3 and 4, the resilient element 84 is located between each locking shoe 66 and the drive head hub 58 for biasing each locking shoe 66 in a radially inward direction relative to the rotational axis A1 of the centrifuge drive 14. The resilient element 84 may be a compression spring sandwiched between the first radially extending surface 94 of each recess 62 and the first radially extending sidewall 104 of each locking shoe 66. To this end, the first radially extending surface of each recess 62 may include a blind bore 110 formed therein and the first radially extending sidewall 104 of each locking shoe 66 may include a blind bore 112 formed therein, with each blind bore 110, 112 being configured to receive a respective end of the compression spring 84, as shown in FIG. 3, for example.

With reference to FIGS. 1-2, 5 and 8, the retaining plate 60 is generally shaped as an annular disc and is configured to be attached to the base 80 of the drive head hub 58 to limit axial movement of each of the plurality of locking shoes 66 within each respective recess 62. The retaining plate 60 further includes a plurality of counterbores 114 formed in a top surface 116 of the retaining plate 60 (e.g., FIG. 5). The counterbores 114 are spaced apart about the retaining plate 60 in a manner that corresponds to the spacing of the locking shoes 66 and recesses 62 formed in the drive head hub 58. As described in further detail below, each counterbore 114 is configured to movably receive a portion of the hinge member 90 of each locking shoe 66. The retaining plate 60 is attached to the drive head hub 58 with fasteners 118 received through respective mounting bores 120 formed in the retaining plate 60. The fasteners 118 may be screws or bolts, for example, and each mounting bore 120 may include a countersink configured to receive a head of the fastener 118 therein, as shown in FIG. 2, for example.

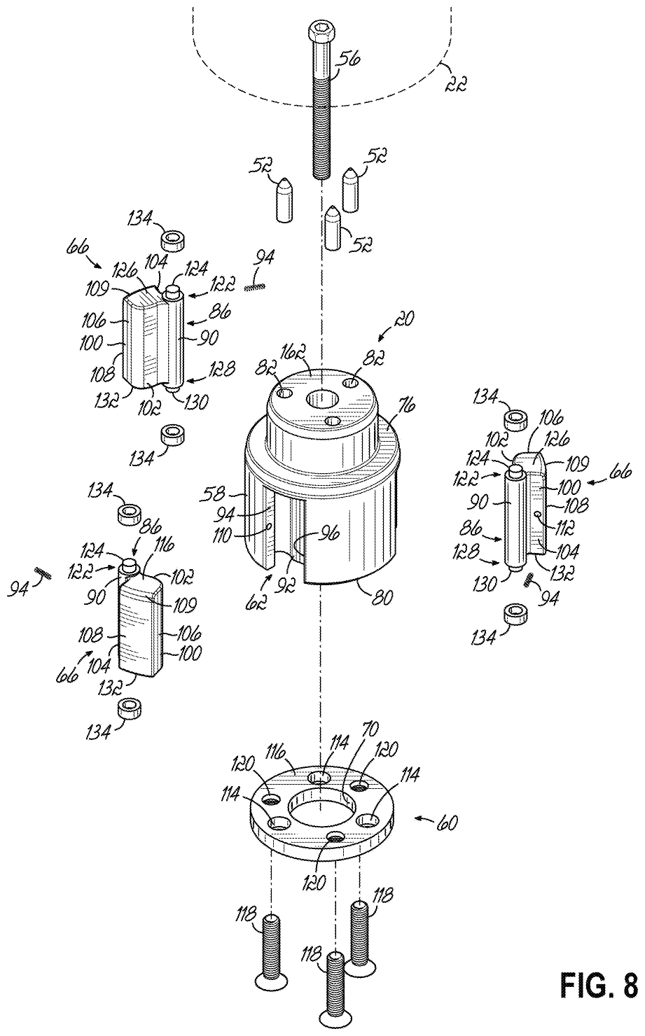

Referring now to FIGS. 5 and 8, the hinge member 90 of each locking shoe 66 extends a height of the locking shoe 66 and includes a first end 122 having a first peg 124 that projects from a top surface 126 of the locking shoe 66 and a second end 128 having a second peg 130 that projects from a base surface 132 of the locking shoe 66. The height of each locking shoe 66 is a distance measured between the top surface 126 of the locking shoe 66 and the base surface 132. In any event, the first peg 124 and the second peg 130 each include a bushing 134 to facilitate pivotal movement of the locking shoe 66, and more particularly the hinge member 90, as described in further detail below. As shown in FIG. 5, the first end 122 of the hinge member 90 is positioned within a blind bore 136 formed by the socket portion 88 of the recess 62. In that regard, the bushing 134 is received about the first peg 124 and sandwiched between the first end 122 of the locking shoe 66 and a base of the blind bore 136. This engagement spaces a portion of the top surface 126 of the locking shoe 66 that is defined by the boss 100 away from the drive head hub 58, as shown in FIG. 2, for example. The second end 128 of each hinge member 90 is positioned within a respective counterbore 114 formed in the retaining plate 60. In that regard, the bushing 134 received about the second peg 130 is sandwiched between the second end 128 of the locking shoe 66 and the retaining plate 60. This engagement spaces a portion of the base surface 132 of the locking shoe 66 that is defined by the boss 100 away from the drive head hub 58, as shown in FIG. 2, for example. The bushings 134 may be formed from an engineered plastic such as Delrin®, for example, or any other suitable low friction material.

Having now described certain details of the rotor 12 and the drive head 20 of the centrifuge 10, the tool-less engagement between the drive head 20 and the hub 22 of the rotor 12 will now be described. In that regard, when the rotor 12 is to be connected with the drive head 20, the rotor 12 is positioned over the drive head 20 to align the drive head 20 within the hub 22 of the rotor 12. The rotor 12 is then moved downwardly until the drive head 20 is fully seated within the hub 22 of the rotor 12, as shown in FIG. 2. When so positioned, the drive pins 52 are correctly positioned within respective torque slots 50 in the hub 20 of the rotor 12 for transferring rotational movement of the centrifuge drive 14 to the centrifuge rotor 12, as described in further detail below. Furthermore, as the locking shoes 66 are biased to the first, retracted position by each resilient element 84, as shown in FIG. 3, the locking shoes 66 do not interfere with the installation of the rotor 12 to the drive head 20 or the removal of the rotor 12 from the drive head 20.

Referring now to FIGS. 3 and 4, and as briefly described above, each locking shoe 66 is configured to exert a radially outwardly directed force on the hub 22 of the rotor 12 that increases with a rising rotational speed of the drive head 20. The radially outwardly directed force exerted by each locking shoe 66 on the hub 22 of the rotor 12 serves to prevent axial movement of the centrifuge rotor 12 along the rotational axis A1 of the centrifuge drive 14 as well as rotational movement of the centrifuge rotor 12 relative to the drive head 20. In that regard, FIG. 3 illustrates the each locking shoe 66 in the retracted position when the rotor 12 is stationary with the curved outer surface 108 of each locking shoe 66 moved away from the interior sidewall 48 of the hub 22 of the rotor 12.

FIG. 4 illustrates each locking shoe 66 in an extended position and further illustrates the contact force between each locking shoe 66 and the hub 22, as indicated by directional arrows A4, when the rotor 12 is rotating at a particular speed, as indicated by directional arrows A5. As the curvature of the curved outer surface 108 of each locking shoe 66 matches, or coincides with the curvature of the interior sidewall 48 of the rotor hub 22, the entirety of the curved outer surface 108 of each locking shoe 66 engages the interior sidewall 48. During rotation of the rotor 12 by the drive head 20, a centrifugal force component F_{c} based on a rotational speed of the drive head 20 overcomes the biassing force exerted by the resilient element 84 to pivot each locking shoe 66 in a radially outwardly direction and into engagement with the interior sidewall 48 of the rotor hub 22. The centrifugal force component F_{c} of each locking shoe 66 can be determined using the following formula: F_{c}=m*r*Ω², where “m” is the weight of the locking shoe 66, “r” is the distance between the rotational axis A1 of the rotor 12 and a center of mass of the locking shoe 66, and “Ω” is a rotational velocity of the rotor 12. As the rotational speed of the drive head 20 increases, and thus a rotational speed of the rotor 12, the centrifugal force component F_{c} acting on each locking shoe 66 also increases, thereby increasing the contact force A4 between each locking shoe 66 and the rotor hub 22. Testing was run on a prototype of the centrifuge 10 assembly described above to determine the combined centrifuge forces (F_{c}*3) imparted by the locking shoes 66 to the rotor hub 22. Table 1 below illustrates those testing results.

TABLE 1

| | Rotor rotational speed in revolutions-per-minute (rpm) | | | | | | | | |
|---|---|---|---|---|---|---|---|---|---|
| | 3000 | 5000 | 10000 | 12000 | 14000 | 16500 | 21000 | 30000 | 40000 |
| Combined | 89 | 247 | 987 | 1,421 | 1,934 | 2,687 | 4,353 | 8,883 | 15,792 |
| centrifugal | | | | | | | | | |
| force | | | | | | | | | |
| component | | | | | | | | | |
| of locking | | | | | | | | | |
| shoes in | | | | | | | | | |
| Newtons | | | | | | | | | |
| (F_{c}*3) | | | | | | | | | |

To this end, deceleration of the rotor 12 decreases the contact force A4 between each locking shoe 66 and the hub 22.

The contact force A4 between each locking shoe 66 and the hub 22 results in a static friction coefficient F_{sf} (e.g., a radial and an axial holding force, otherwise referred to as a friction force) between each locking shoe 66 and the interior sidewall 48 of the rotor hub 22. In that regard, the static friction coefficient F_{sf} is a function of the coefficient of friction “μ” between the contacting surfaces 108, 48 and the contact force A4. That is, F_{sf}=μ*F_{c}. Generally, as the contact force A4 increases with the increase of rotor 12 speed, so does the static friction coefficient F_{sf} (e.g., the radial and axial holding forces). As each locking shoe 66 and the hub 22 of the rotor 12 may be formed from steel, such as 316L stainless steel, for example, the coefficient of friction u between the curved outer surface 108 of each locking shoe 66 and the sidewall 48 of the rotor hub 22 may be between 0.3 to 0.5, for example. However, the surface roughness of the curved outer surface 108 of each locking shoe 66 and the sidewall 48 of the rotor hub 22 may be changed to improve the coefficient of friction u therebetween. For example, the surfaces 108, 48 may be machined and processed with different Ra (roughness average), such as 15 Ra, for example, resulting in a coefficient of friction u therebetween that is within a range of between 0.3 to 0.8, for example.

In view of the above, the weight of each locking shoe 66 is an important design requirement for the operation of the drive head 20. In that regard, the weight of each locking shoe 66 should be as heavy as possible to increase the value of F_{sf}, particularly at lower rotational speeds of the rotor 12. To this end, the three locking shoe 66 design provides for both the self-centering effect of the drive head hub 20 as well as a large size and mass of each locking shoe 66. Thus, while it is possible to have fewer or more locking shoes 66, such as two or four, for example, each design sacrifices either the self-centering effect (e.g., two locking shoes 66) or requires a smaller size and thus smaller mass of each locking shoe 66 (e.g., four locking shoes 66).

During the above-mentioned testing, another advantage of the connection between the drive head 20 and the rotor 12 during operation of the centrifuge 10 was observed. In that regard, the centrifuge 10 was observed to be exceptionally quiet during operation, and the decibel (dB) output was measured to be 57.6 dB at a rotational speed of 10,000 rpm.

Referring now to FIGS. 2 and 6-7, when the drive head 20 is fully seated within the rotor hub 22, as shown in FIG. 2, the rotor 12 is considered mounted to the centrifuge drive 14. When so positioned, the drive pins 52 are received within respective torque slots 50 and configured to engage a sidewall 138 of each respective torque slot 50 to minimize movement of the drive head 20 relative to the rotor 12 during initial acceleration or deceleration of the rotor 12 by the drive 14. The engagement between the drive pins 52 and the torque slots 50 may also transfer rotational movement of the centrifuge drive 14 to the centrifuge rotor 12 during initial acceleration or deceleration of the rotor 12 by the drive 14. As shown in FIGS. 6-7, the torque slots 50 are formed as oblong arc-shaped blind bores having a slightly curved profile that generally conforms to circumference of the base surface 46 of the rotor hub 22. In that regard, the torque slots 50 are formed in the base surface 46 of the rotor hub 22 and are spaced apart circumferentially, in an end-to-end symmetrical arrangement, about the axial center of the hub 22 which is coaxial with the rotational axis A1. To this end, while the rotor hub 22 includes four torque slots 50, it is possible to provide fewer or more torque slots 50.

With reference to FIGS. 6-7, the drive head 20 is fully seated within the rotor hub 22 resulting in a first drive pin 52 being positioned within a first torque slot 50, a second drive pin 52 being positioned within a second torque slot 50, and a third drive pin 52 being positioned within a third torque slot 50. In particular, the first drive pin 52 is in an abutting or near-abutting relationship with a rightmost arcuate portion 140 of the sidewall 138 of the first torque slot 50 (i.e., a rightmost portion of the torque slot sidewall 138 measured in a radial direction about the axial center of the rotor hub 22) and the second drive pin 52 is positioned in an abutting or near-abutting relationship with a leftmost arcuate portion 142 of the sidewall 138 of the second torque slot 50 (i.e., a leftmost portion of the torque slot sidewall 138 measured in a radial direction about the axial center of the rotor hub 22). The third drive pin 52 is positioned centrally within the third torque slot 50. As shown, the first drive pin 52 and the second drive pin 52 do not both abut the arcuate portions 140, 142 of the sidewalls 138 of the first and second torque slots 50 at the same time. Rather, only one of the drive pins 52 is in an abutting relationship with the respective arcuate portion 140, 142 of the torque slot sidewall 138, depending on whether the rotor 12 is being accelerated or decelerated. This configuration results in a small gap being formed between the drive pin 52 and the corresponding sidewall 138 that are not engaged, as described in further detail below.

FIG. 6 illustrates the rotor 12 being accelerated to a particular rotational speed by the drive head 20, as indicated by directional arrows A6. As shown, during acceleration, the first drive pin 52 is in an abutting relationship with the rightmost arcuate portion 140 of the sidewall 138 of the first torque slot 50 to transfer torque from the drive head 20 to the rotor 12, as indicated by directional arrow A7. To this end, the engagement between the first drive pin 52 and the first torque slot 50 prevents rotation of the drive head 20 relative to the centrifuge rotor 12 during acceleration of the centrifuge rotor 12 by the centrifuge drive 14. Also during acceleration of the rotor 12, the second drive pin 52 is spaced away from the leftmost arcuate portion 142 of the sidewall 138 of the second torque slot 50 such that a gap 144 is formed therebetween.

FIG. 7 illustrates the rotor 12 during deceleration or braking, as indicated by directional arrows A8. In that regard, the rotor 12 is rotating at a particular rotational speed that is less than the speed of the rotor 12 illustrated in FIG. 6. As shown, during deceleration, the second drive pin 52 is in an abutting relationship with the leftmost arcuate portion 142 of the sidewall 138 of the second torque slot 50 to transfer torque from the drive head 20 to the rotor 12, as indicated by directional arrow A9. To this end, the engagement between the second drive pin 52 and the second torque slot 50 prevents rotation of the drive head 20 relative to the centrifuge rotor 12 during deceleration of the centrifuge rotor 12 by the centrifuge drive 14. Also during deceleration of the rotor 12, the first drive pin 52 is spaced away from the rightmost arcuate portion 140 of the sidewall 138 of the first torque slot 50 such that a gap 146 is formed therebetween. The size of the gap 146 may the similar to the gap 144 described above with respect to FIG. 6.

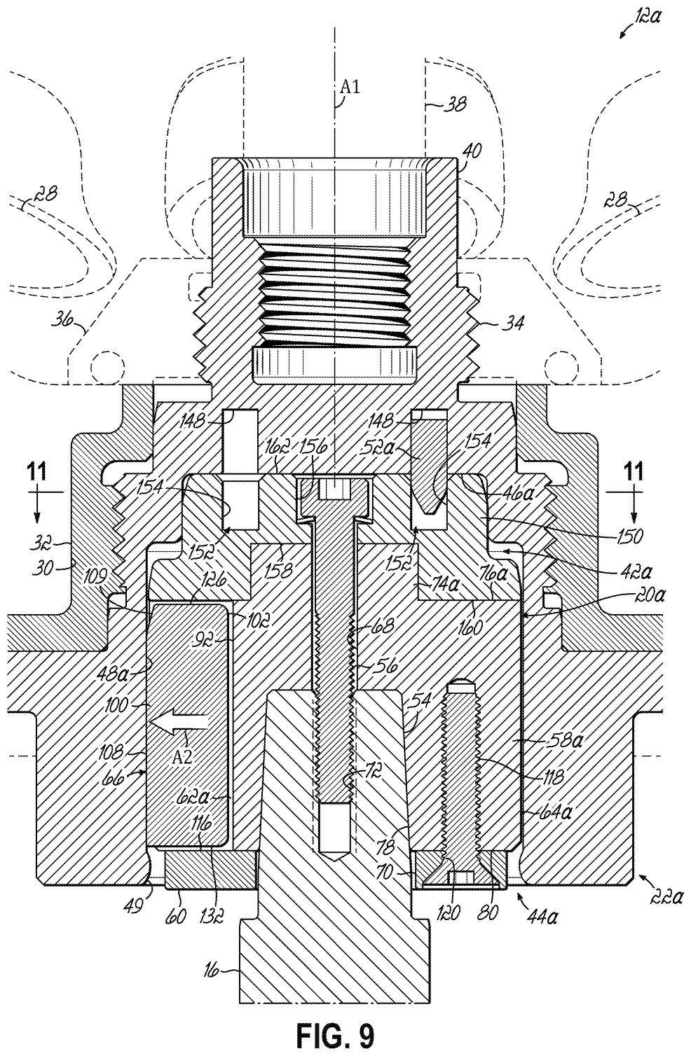

Referring now to FIGS. 9-12, wherein like numerals represent like features, a second embodiment of the drive head 20a of the present invention is shown and will now be described. Like the previously described embodiment, the drive head 20a forms part of the centrifuge 10a and is used to detachably couple a centrifuge rotor 12a to the spindle 16 of the centrifuge drive 14 that is driven by the motor 18 to thereby rotate the rotor 12 about the rotational axis A1 to achieve high-speed, centrifugal rotation of the rotor 12. The primary differences between the centrifuge 10a of this embodiment and the centrifuge 10 of the previously described embodiment is the configuration of the drive head 20a and the configuration of the rotor hub 22a. To this end, while the centrifuge 10a and the centrifuge drive 14a are not entirely shown in FIG. 9, it is understood that they are similar to the centrifuge 10 and the centrifuge drive 14 described above with respect to FIG. 1, for example.

With reference to FIG. 9, the exemplary centrifuge rotor 12a is similar in many respects to the rotor 12 described above with respect to FIGS. 1-7, and thus like reference numerals represent like features. As such, certain features will not be redescribed. As shown, the rotor 12a includes the rotor hub 22a which defines the internal cavity 42a configured to receive the drive head 20a of the centrifuge drive 14a therein for coupling the rotor 12 to the centrifuge drive 14a in a tool-less manner. The internal cavity 42a extends from an open end 44a of the hub 22 to a radially extending base surface 46a of the hub 22a to define an interior sidewall 48a of the hub 22. The base surface 46a of the hub 22a includes a plurality of blind bores 148 formed therein with each blind bore 148 being configured to receive a corresponding drive pin 52a therein to transfer rotational movement of the centrifuge drive 14a to the centrifuge rotor 12a, as described in further detail below.

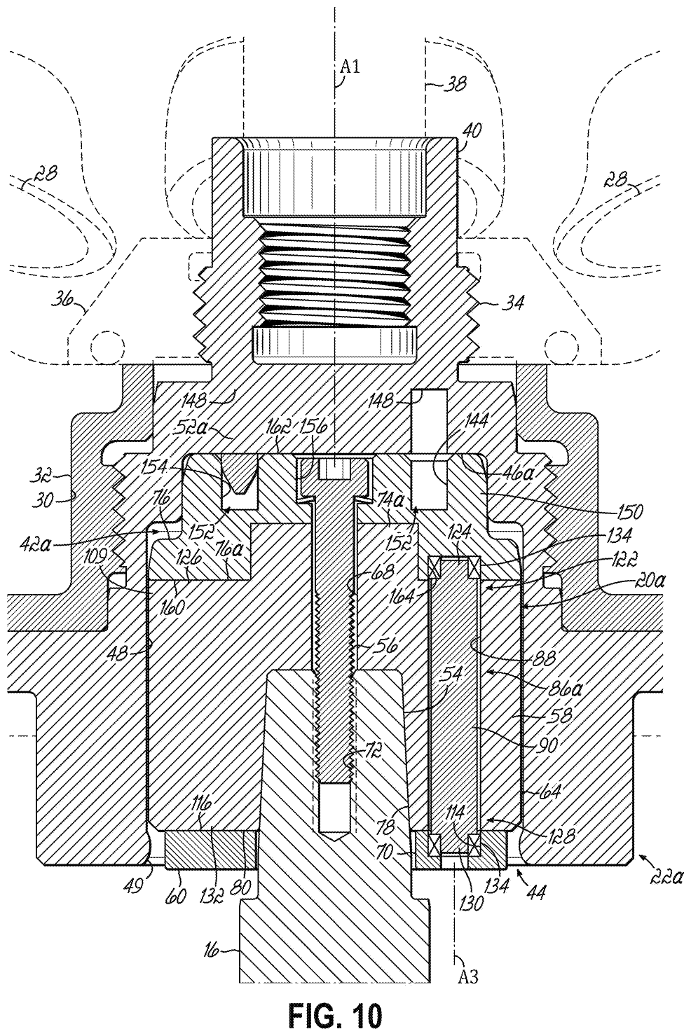

Each blind bore 148 is configured to receive a corresponding drive pin 52a therein and, in the embodiment shown, the hub 22a includes three blind bore 148 and drive pin 52a combinations. The blind bore 148 and drive pin 52a combinations are spaced 120° apart from each other about the axial center of the hub 22 which is coaxial with the rotational axis A1 (e.g., FIGS. 9 and 10). However, the hub 22a may include fewer or more blind bore 148 and drive pin 52a combinations spaced apart in different configurations about the axial center of the hub 22a. For example, the hub 22a may include two blind bore 148 and drive pin 52a combinations spaced 180° apart from each other about the axial center of the hub 22a. In any event, the engagement between each drive pin 52a and blind bore 148 is an interference fit, otherwise referred to as a press-fit. As a result, there may be a void between a base of each blind bore 148 and the drive pin 52a, as shown in FIG. 9, for example. However, it is understood that the drive pins 52a may be attached to the hub 22a in other ways, such as by welding or by threaded engagement, for example. In one embodiment, the hub 22a and drive pins 52a may be integrally formed as a unitary piece.

With reference to FIG. 9, the drive head 20a is mounted to the distal end 54 of the spindle 16 with a fastener 56 and includes a drive head hub 58a, a crown 150, and a retaining plate 60 coupled together in a coaxial arrangement. When the drive head 20a is fully seated within the rotor hub 22a, as shown in FIG. 9, the drive pins 52a are received within respective torque slots 152 formed in the crown 150 to thereby engage a sidewall 154 of each respective torque slot 152 to minimize movement of the drive head 20a relative to the rotor 12a during initial acceleration or deceleration of the rotor 12a by the drive 14a, as will be described in further detail below. The crown 150, drive head hub 58a and the retaining plate 60 each include a central bore 156, 68, 70, respectively. The central bores 156, 68 formed in the crown 150 and the drive head hub 58a, respectively, are configured to receive the fastener 56 therethrough for attaching the drive head 20a to the distal end 54 of the spindle 16, as shown.

Like the drive head hub 58 described above with respect to FIGS. 1-8, the drive head hub 58a includes a plurality of radially movable locking shoes 66 that are configured to exert a radially outwardly directed force on the hub 22a of the rotor 12a that increases with a rising rotational speed of the drive head 20a. Each locking shoe 66 is movably retained within a corresponding recess 62a formed in an outer sidewall 64a of the drive head hub 58a. A resilient element 84 is located between each locking shoe 66 and the drive head hub 58a, and each locking shoe 66 is movable within a corresponding recess 62a in a radially inward direction and a radially outward direction relative to the rotational axis A1 of the centrifuge drive 14a. To this end, each locking shoe 66 is configured to exert a radially outwardly directed force on the interior sidewall 48a of the hub 22a of the centrifuge rotor 12a, that increases with a rising rotational speed of the drive head 20a, to prevent axial movement of the centrifuge rotor 12a along the rotational axis A1 of the centrifuge drive 14a and rotational movement of the centrifuge rotor 12a relative to the drive head 20a.

With continued reference to FIG. 9, the crown 150 is configured to be attached to the drive head hub 58a and includes a pocket 158 formed in a base 160 of the crown 150 that is configured to receive the boss 74a of the drive head hub 58a therein for coupling the crown 150 to the drive head hub 58a. In that regard, the boss 74a of the drive head hub 58a is configured to be fully received within the pocket 158 of the crown 150 to thereby place the base 160 of the crown 150 in engagement with the top surface 76a of the drive head hub 58a. To this end, the fit between the pocket 158 of the crown 150 and the boss 74a of the drive head hub 58a may be an interference fit, for example. The crown 150 further includes the plurality of torque slots 152 formed in a top surface 162 of the crown 150 with each torque slot 152 being configured to receive a corresponding drive pin 52a therein to transfer rotational movement of the centrifuge drive 14a to the centrifuge rotor 12a, as described in further detail below. The central bore 156 formed in the crown 150 extends in an axial direction between the top surface 162 and the pocket 158 of the crown 150 and may include a countersink formed in the top surface 162 that is configured to receive a head of the fastener 56 therein, as shown.

With reference to FIG. 10, the base 160 of the crown 150 includes a plurality of blind bores 164 formed therein. As shown in FIG. 10, each blind bore 164 is configured to movably receive the first end 122 of the hinge member 90 of a respective locking shoe 66 therein. As such, the blind bores 164 are spaced apart about the crown 150 in a manner that corresponds to the spacing of the locking shoes 66 and recesses 62a formed in the drive head hub 58a. To this end, each locking shoe 66 is movably retained within a corresponding recess 62a by the crown 150 and the retaining plate 60. As shown, the first end 122 of each hinge member 90 is positioned within a corresponding blind bore 164 formed in the crown 150 such that the bushing 134 received about the first peg 124 is sandwiched between the locking shoe 66 and the crown 150. This engagement spaces a portion of the top surface 126 of the locking shoe 66 that is defined by the boss 100 away from the crown 150, as shown in FIG. 10, for example. The second end 128 of each hinge member 90 is positioned within a respective counterbore 114 formed in the retaining plate 60. In that regard, the bushing 134 received about the second peg 130 is sandwiched between the locking shoe 66 and the retaining plate 60. This engagement spaces a portion of the base surface 132 of the locking shoe 66 that is defined by the boss 100 away from the retaining plate 60, as shown in FIG. 10, for example. To this end, the engagement between the hinge member 90 and the drive head hub 58a, crown 150, and retaining plate 60 defines the hinge joint 86a.

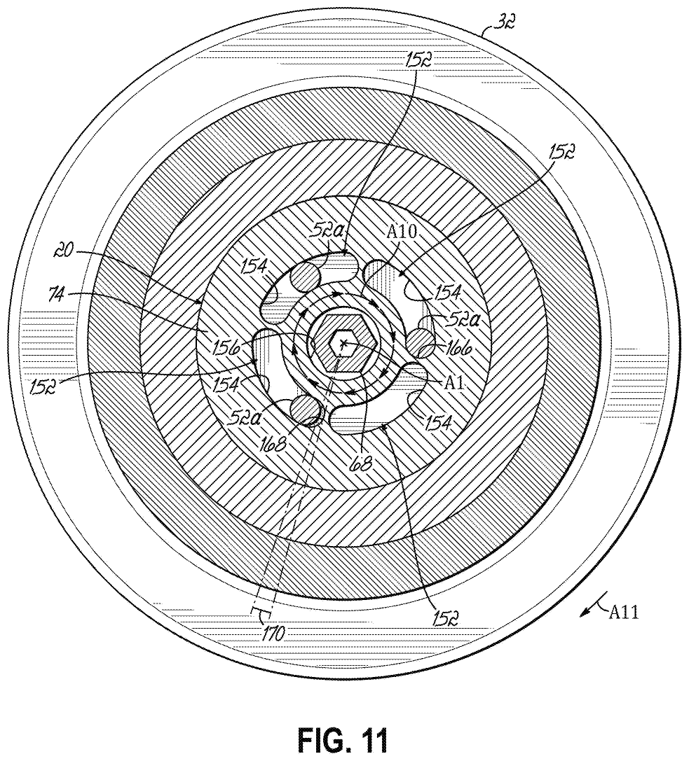

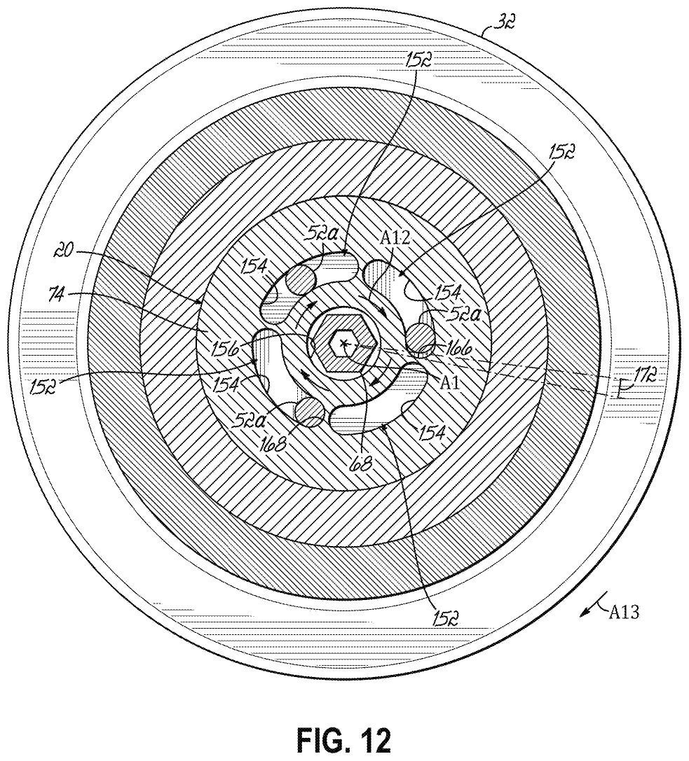

With reference to FIGS. 11-12, the drive head 20a is fully seated within the rotor hub 22a resulting in a first drive pin 52a being positioned within a first torque slot 152, a second drive pin 52a being positioned within a second torque slot 152, and a third drive pin 52a being positioned within a third torque slot 152. In particular, the first drive pin 52a is in an abutting or near-abutting relationship with a rightmost arcuate portion 166 of the sidewall 154 of the first torque slot 152 (i.e., a rightmost portion of the torque slot sidewall 154 measured in a radial direction about the axial center of the rotor hub 22a) and the second drive pin 52a is positioned in an abutting or near-abutting relationship with a leftmost arcuate portion 168 of the sidewall 154 of the second torque slot 152 (i.e., a leftmost portion of the torque slot sidewall 154 measured in a radial direction about the axial center of the rotor hub 22a). The third drive pin 52a is positioned centrally within the third torque slot 152. As shown, the first drive pin 52a and the second drive pin 52a do not both abut the arcuate portions 166, 168 of the sidewalls 154 of the first and second torque slots 152 at the same time. Rather, only one of the drive pins 52a is in an abutting relationship with the respective arcuate portion 166, 168 of the torque slot sidewall 154, depending on whether the rotor 12a is being accelerated or decelerated. This configuration results in a small gap being formed between the drive pin 52a and the corresponding sidewall 138 that are not engaged, as described in further detail below.

FIG. 11 illustrates the rotor 12a being accelerated to a particular rotational speed by the drive head 20a, as indicated by directional arrows A10. As shown, during acceleration, the first drive pin 52a is in an abutting relationship with the rightmost arcuate portion 166 of the sidewall 154 of the first torque slot 152 to transfer torque from the drive head 20a to the rotor 12a, as indicated by directional arrow A11. To this end, the engagement between the first drive pin 52a and the first torque slot 152 prevents rotation of the drive head 20a relative to the centrifuge rotor 12a during acceleration of the centrifuge rotor 12a by the centrifuge drive 14a. Also during acceleration of the rotor 12a, the second drive pin 52a is spaced away from the leftmost arcuate portion 168 of the sidewall 154 of the second torque slot 152 such that a gap 170 is formed therebetween.

FIG. 12 illustrates the rotor 12a during deceleration or braking, as indicated by directional arrows A12. In that regard, the rotor 12a is rotating at a particular rotational speed that is less than the speed of the rotor 12a illustrated in FIG. 11. As shown, during deceleration, the second drive pin 52a is in an abutting relationship with the leftmost arcuate portion 168 of the sidewall 154 of the second torque slot 152 to transfer torque from the drive head 20a to the rotor 12a, as indicated by directional arrow A13. To this end, the engagement between the second drive pin 52a and the second torque slot 152 prevents rotation of the drive head 20a relative to the centrifuge rotor 12a during deceleration of the centrifuge rotor 12a by the centrifuge drive 14a. Also during deceleration of the rotor 12a, the first drive pin 52a is spaced away from the rightmost arcuate portion 166 of the sidewall 154 of the first torque slot 152 such that a gap 172 is formed therebetween. The size of the gap 172 may the similar to the gap 170 described above with respect to FIG. 11.

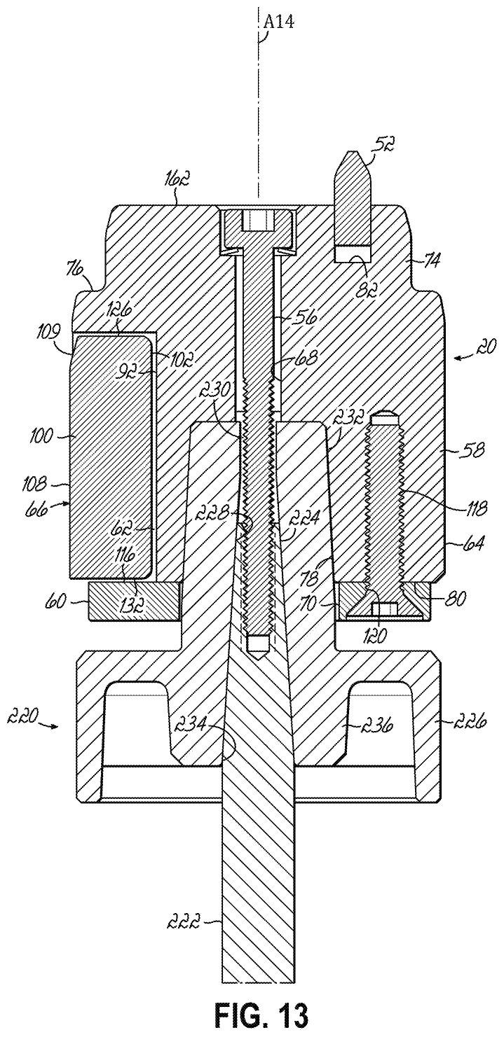

Referring now to FIG. 13, wherein like numerals represent like features, details of an adapter 220 for attaching either of the above-described drive heads 20, 20a to a spindle 222 of a centrifuge (not shown) that has different dimensions compared to the spindle 16 of the centrifuges 10, 10a described above are shown in accordance with another embodiment of the invention. In that regard, the distal end 224 of the spindle 222 is smaller in diameter compared to the distal end 54 of the spindle 16 described above, and consequently would not properly fit within the pocket 78 formed in the base 80 of the drive head hub 58. In another embodiment, an adapter may be provided to attach the drive head 20, 20a to the distal end 224 of a spindle that is larger in diameter compared to the distal end 54 of the spindle 16 described above. As described in further detail below, the adapter 220 fits to the distal end 224 of the spindle 222 and a portion of the adapter 220 is received within the pocket 78 of the drive head hub 58 so that the drive head 20 may be operably coupled to the spindle 222.

With continued reference to FIG. 13, the adapter 220 includes a cupped flange 226 and a mounting bore 228 that extends axially through the adapter 220 and between a first opening 230 to the mounting bore 228 formed in a first projection 232 of the adapter 220 and a second opening 234 to the mounting 228 formed in a second projection 236 of the adapter 220. The first and second projections 232, 236 project from the flange in axially opposite directions such that the mounting bore 228 is formed through the axial center of the adapter 220. As shown, the axial center of the adapter 220 is coaxial with an axis of rotation A14 of the spindle 222, the drive head 20, and the adapter 220. The first opening 230 formed in the first projection 232 has a diameter that is smaller in size compared to a diameter of the second opening 234 formed in the second projection 236. In that regard, a diameter of the mounting bore 228 gradually decreases in size along an axial length of the mounting bore 228 and in a direction from the second opening 234 to the first opening 230. As such, the mounting bore 228 is generally frustoconical in shape. To this end, the configuration of the mounting bore 228 may be changed depending on the type of centrifuge being used.

As shown, the second opening 234 is configured to receive the distal end 224 of the spindle 222 therethrough and the first opening 230 is configured to receive a fastener 238 therethrough for securing the adapter 220 and the drive head 220 to the spindle 222. In that regard, the distal end 224 of the spindle 222 is received into the mounting bore 228 through the second opening 234 to position the distal end 224 of the spindle 222 within the mounting bore 228, as shown. The fit between the distal end 224 of the spindle 222 and the mounting bore 228 may be a friction fit to secure the adapter 220 to the spindle 222, for example. To this end, the mounting bore 228 may have different configurations based on the configuration of the spindle 222. For example, the mounting bore 228 may have a constant diameter between the first opening 230 and the second opening 234.

The first projection 232 of the adapter 220 is generally frustoconical in shape and is sized to be received within the pocket 78 of the drive head hub 58 to couple the drive head 20 to the adapter 220, as shown. That is, an outer profile of the first projection 232 generally corresponds to a profile of the pocket 78. The fit between the first projection 232 of the adapter 220 and the pocket 78 of the drive head hub 58 may be a friction fit, for example. The adapter 220 is configured to be sandwiched between the drive head 20 and the distal end 224 of the spindle 222 in a coaxial arrangement, as shown, with the drive head 20 and the adapter 220 being mounted to the distal end 54 of the spindle 16 with the fastener 238. To this end, the fastener 238, which may be a bolt or screw, for example, is received through aligned bores 68, 228 and threaded into a threaded bore 240 in the distal end 224 of the spindle 222 to secure the drive head 20 and the adapter 220 to the spindle 222.

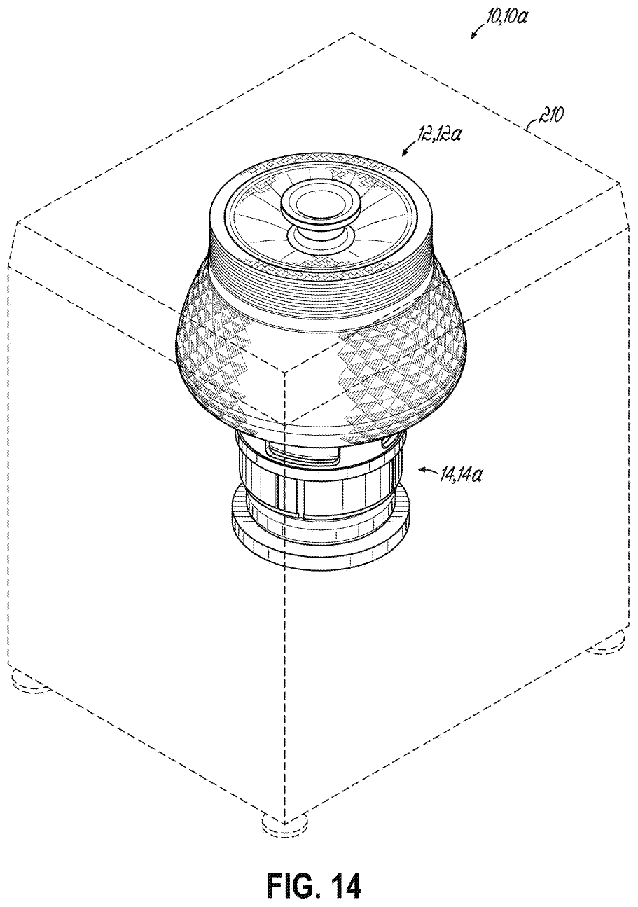

FIG. 14 depicts the exemplary centrifuge 10, 10a which includes a housing 210, the drive 14, 14a, and one of the above-described rotors 12, 12a coupled to the drive 14, 14a with one of the above-described drive heads 20, 20a. In operation, the drive 14, 14a imparts rotation to the spindle (not shown) that, in turn, provides a rotational torque to the rotor 12, 12a to rotate the rotor 12, 12a at a desired speed.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1. A drive head for a centrifuge drive that is configured to be received within a hub of a centrifuge rotor for coupling the centrifuge rotor to the centrifuge drive for rotation of the centrifuge rotor by the centrifuge drive about a rotational axis of the centrifuge drive, the hub of the centrifuge rotor having at least one torque slot formed therein, the drive head comprising:
a drive head hub including a spindle socket configured to receive a spindle of the centrifuge drive and a central bore configured to receive a fastener therethrough to couple the drive head to the spindle, the drive head hub comprising:
a boss that projects upwardly from a top surface of the drive head hub, the boss including at least one drive pin configured to engage the at least one torque slot formed in the hub of the centrifuge rotor to transfer rotational movement of the centrifuge drive to the centrifuge rotor;
a plurality of recesses formed in an outer sidewall of the drive head hub and spaced circumferentially about the drive head hub;
a locking shoe movably retained within each of the plurality of recesses to define a hinge joint and a hinge axis and pivotable about the hinge axis in a radially inward direction and a radially outward direction relative to the rotational axis of the centrifuge drive; and
a resilient element located between each locking shoe and the drive head hub for biasing each locking shoe in the radially inward direction relative to the rotational axis of the centrifuge drive:
wherein each locking shoe is configured to exert a radially outwardly directed force on an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

2. The drive head of claim 1, further comprising a retaining plate attached to a base of the drive head hub, the retaining plate including a central bore configured to receive a distal end of the spindle therethrough, or wherein the at least one drive pin comprises a first, second, and third drive pin spaced apart circumferentially about the central bore of the drive head hub.

3. The drive head of claim 1, wherein each locking shoe includes a curved outer surface in transverse cross-section that matches a curvature of the interior sidewall of the hub of the centrifuge rotor, and wherein each locking shoe includes a chamfered surface that extends between the curved outer surface and a top surface of each locking shoe.

4. (canceled)

5. The drive head of claim 1, wherein each locking shoe is pivotable between:
a retracted position wherein each locking shoe is received within a corresponding one of the plurality of recesses in a radially inward direction relative to the rotational axis of the centrifuge drive to define a first outer diameter of the drive head hub; and
an extended position wherein each locking shoe projects a distance from the corresponding one of the plurality of recesses in a radially outward direction relative to the rotational axis of the centrifuge drive to define a second outer diameter of the drive head hub that is greater than the first outer diameter.

6. The drive head of claim 1, wherein the plurality of recesses are spaced equidistantly apart about a circumference of the drive head hub to provide self-centering of the drive head within the hub of the centrifuge rotor by each locking shoe, or wherein the hinge axis is in parallel with the rotational axis of the centrifuge drive.

7. (canceled)

8. The drive head of claim 2, wherein each locking shoe includes a hinge member configured to be movable within a socket portion of each of the plurality of recesses and a bore formed in the retaining plate to define the hinge joint, and wherein a first end of the hinge member includes a peg having a bushing configured to facilitate pivotal movement between the locking shoe and the drive head hub and a second end of the hinge member includes a peg having a bushing configured to facilitate pivotal movement between the locking shoe and the retaining plate.

9. (canceled)

10. The drive head of claim 5, wherein the locking shoe includes a first radially extending sidewall portion and a second radially extending sidewall portion, the first radially extending sidewall portion being configured to abut a first radially extending surface of the drive head hub when the locking shoe is in the extended position and the second radially extending sidewall portion being configured to abut a second radially extending surface of the drive head hub when the locking shoe is in the retracted position, and wherein the resilient element extends between a blind bore formed in the first radially extending surface of the drive head hub and a blind bore formed in the first radially extending sidewall portion of the locking shoe.

11. (canceled)

12. (canceled)

13. A centrifuge, comprising:
the drive head of claim 1; and
a centrifuge rotor including a hub configured to receive the drive head therein, the hub including at least one torque slot formed therein that is configured to receive the at least one drive pin of the drive head hub for transferring rotational movement of the centrifuge drive to the centrifuge rotor.

14. The centrifuge of claim 13, wherein each torque slot is an arc-shaped blind bore, and wherein the at least one torque slot comprises four torque slots spaced apart circumferentially about a central bore formed in the hub.

15. (canceled)

16. The centrifuge of claim 13, wherein a first drive pin of the drive head hub is configured to engage a sidewall of a first torque slot to prevent rotation of the drive head relative to the centrifuge rotor during acceleration of the centrifuge rotor by the centrifuge drive, and wherein a second drive pin of the drive head hub is configured to engage a sidewall of a second torque slot to prevent rotation of the drive head relative to the centrifuge rotor during deceleration of the centrifuge rotor by the centrifuge drive.

17. (canceled)

18. A drive head for a centrifuge drive that is configured to be received within a hub of a centrifuge rotor for coupling the centrifuge rotor to the centrifuge drive for rotation of the centrifuge rotor by the centrifuge drive about a rotational axis of the centrifuge drive, the hub of the centrifuge rotor having at least one drive pin for transferring rotational movement of the centrifuge drive to the centrifuge rotor, the drive head comprising:
a drive head hub including a spindle socket configured to receive a spindle of the centrifuge drive and a central bore configured to receive a fastener therethrough to couple the drive head to the spindle, the drive head hub comprising:
a plurality of recesses formed in an outer sidewall of the drive head hub and spaced circumferentially about the drive head hub;
a locking shoe movably retained within each of the plurality of recesses to define a hinge joint and a hinge axis and pivotable about the hinge axis in a radially inward direction and a radially outward direction relative to the rotational axis of the centrifuge drive; and
a resilient element located between each locking shoe and the drive head hub for pivotally biasing each locking shoe in the radially inward direction relative to the rotational axis of the centrifuge drive:
wherein each locking shoe is configured to exert a radially outwardly directed force on an interior sidewall of the hub of the centrifuge rotor during rotation of the centrifuge rotor by the centrifuge drive to prevent axial movement of the centrifuge rotor along the rotational axis of the centrifuge drive and rotational movement of the centrifuge rotor relative to the drive head, with the radially outwardly directed force increasing with a rising rotational speed of the drive head.

19. The drive head of claim 18, further comprising:
a crown attached to a top of the drive head hub, the crown including a central bore configured to receive the fastener therethrough and a plurality of torque slots formed in a top surface of the crown that are configured to receive the at least one drive pin of the hub of the centrifuge rotor therein to transfer rotational movement of the centrifuge drive to the centrifuge rotor; and
a retaining plate attached to a base of the drive head hub, the retaining plate including a central bore configured to receive a distal end of the spindle therethrough, wherein each locking shoe includes a curved outer surface in transverse cross-section that matches a curvature of the interior sidewall of the hub of the centrifuge rotor, and wherein each locking shoe includes a chamfered surface that extends between the curved outer surface and a top surface of each locking shoe.

20. (canceled)

21. (canceled)

22. The drive head of claim 18, wherein each locking shoe is pivotable between:
a retracted position wherein each locking shoe is received within a corresponding one of the plurality of recesses in a radially inward direction relative to the rotational axis of the centrifuge drive to define a first outer diameter of the drive head hub; and
an extended position wherein each locking shoe projects a distance from the corresponding one of the plurality of recesses in a radially outward direction relative to the rotational axis of the centrifuge drive to define a second outer diameter of the drive head hub that is greater than the first outer diameter.

23. The drive head of claim 18, wherein the plurality of recesses are spaced equidistantly apart about a circumference of the drive head hub to provide self-centering of the drive head within the hub of the centrifuge rotor by each locking shoe, or wherein the hinge axis is in parallel with the rotational axis of the centrifuge drive.

24. (canceled)

25. The drive head of claim 18, wherein each locking shoe includes a hinge member configured to be movable within a socket portion of each of the plurality of recesses, a blind bore formed in the crown, and a bore formed in the retaining plate to define the hinge joint, and wherein a first end of the hinge member includes a peg having a bushing configured to facilitate pivotal movement between the locking shoe and the crown and a second end of the hinge member includes a peg having a bushing configured to facilitate pivotal movement between the locking shoe and the retaining plate.

26. (canceled)

27. The drive head of claim 22, wherein the locking shoe includes a first radially extending sidewall portion and a second radially extending sidewall portion, the first radially extending sidewall portion being configured to abut a first radially extending surface of the drive head hub when the locking shoe is in the extended position and the second radially extending sidewall portion being configured to abut a second radially extending surface of the drive head hub when the locking shoe is in the retracted position, and wherein the resilient element extends between a blind bore formed in the first radially extending surface of the drive head hub and a blind bore formed in the first radially extending sidewall portion of the locking shoe.

28. (canceled)

29. A centrifuge, comprising:
the drive head of claim 19; and
a centrifuge rotor including a hub configured to receive the drive head therein, the hub including at least one drive pin that projects from an interior surface of the hub in an axially downward direction relative to the rotational axis of the centrifuge drive, the at least one drive pin configured to transfer rotational movement of the centrifuge drive to the centrifuge rotor, wherein each torque slot is an arc-shaped blind bore, and wherein the at least one torque slot comprises four torque slots spaced apart circumferentially about a central bore formed in the hub.

30. (canceled)

31. (canceled)

32. The centrifuge of claim 29, wherein a first drive pin of the crown is configured to engage a sidewall of a first torque slot to prevent rotation of the drive head relative to the centrifuge rotor during acceleration of the centrifuge rotor by the centrifuge drive, and wherein a second drive pin of the crown of the centrifuge rotor is configured to engage a sidewall of a second torque slot to prevent rotation of the drive head relative to the centrifuge rotor during deceleration of the centrifuge rotor by the centrifuge drive.

33. (canceled)

34. An adapter for mounting a drive head to a spindle of a centrifuge drive, the drive head being configured to be received within a hub of a centrifuge rotor for coupling the centrifuge rotor to the centrifuge drive for rotation of the centrifuge rotor by the centrifuge drive about a rotational axis of the centrifuge drive, the drive head including a central bore configured to receive a fastener therethrough to couple the drive head to a distal end of the spindle of the centrifuge drive, the adapter comprising:
a first projection configured to be received within a pocket formed in the drive head;
a second projection that projects in an axially opposite direction from the first projection; and
a mounting bore that extends axially through the adapter and between a first opening to the mounting bore formed in the first projection of the adapter and a second opening to the mounting formed in the second projection of the adapter;
wherein the mounting bore is configured to receive the distal end of the spindle through the second opening such that the central bore of the drive head, the mounting bore, and a threaded bore in the distal end of the spindle are coaxially arranged to receive the fastener therethrough to couple the drive head and the adapter to the distal end of the spindle of the centrifuge drive.

35. The adapter of claim 34, further comprising a cupped flange located axially between the first projection and the second projection, wherein the first projection is frustoconical in shape, or wherein the mounting bore is frustoconical in shape.

36. (canceled)

37. (canceled)
